(19) United States
(12) Patent Application Publication
(10) Pub. No.: US 2025/0077781 A1
(43) Pub. Date: Mar. 6, 2025

(54) CLASSIFICATION METHOD, DEVICE AND STORAGE MEDIUM

(71) Applicant: Lenovo (Beijing) Limited, Beijing (CN)

(72) Inventors: Yimin JING, Beijing (CN); Yao MENG, Beijing (CN); Qin FENG, Beijing (CN)

(21) Appl. No.: 18/821,858

(22) Filed: Aug. 30, 2024

(30) Foreign Application Priority Data
Aug. 31, 2023 (CN) 202311118106.7

(51) Int. Cl. G06F 40/30; G06F 40/253; G06F 40/279; G06F 40/40; G06N 20/00

(52) U.S. Cl. CPC G06F 40/30; G06F 40/253; G06F 40/279; G06F 40/40; G06N 20/00

(57) ABSTRACT

This application provides a classification method, device and storage medium. The classification method includes obtaining text to be processed; and processing the text to be processed based on a text classifier to obtain category information corresponding to the text, wherein the text classifier is generated based on classification guidance information and a generative pre-trained model, and the generative pre-trained model generates target classification data and its corresponding label information needed to train the text classifier based on the classification guidance information.

### CROSS-REFERENCE TO RELATED APPLICATION

This application claims priority to Chinese Patent Application No. 202311118106.7, filed on Aug. 31, 2023, and the entire content of which is incorporated herein by reference.

### TECHNICAL FIELD

The present disclosure relates to the field of computer technology, specifically to a classification method, device and storage medium.

### BACKGROUND

Currently, training a text classifier for a specific vertical domain requires satisfying two fundamental conditions at the data level: first, a well-defined classification system, second, a large amount of training data under each classification label.

However, constructing classification systems and datasets consumes significant resources, including knowledge engineers and data annotators. This leads to high human labor and time costs. Additionally, in certain specialized industries, due to data confidentiality requirements, engineers may only have basic descriptions of the domain without classification infrastructure or data available for reference. As a result, text classifiers often have low accuracy and poor performance.

### SUMMARY

One aspect of the present disclosure provides a classification method. The classification method includes: obtaining text to be processed; and processing the text to be processed based on a text classifier to obtain category information corresponding to the text. The text classifier is generated based on classification guidance information and a generative pre-trained model, and the generative pre-trained model generates target classification data and its corresponding label information needed to train the text classifier based on the classification guidance information.

Another aspect of the present disclosure provides a classification device. The classification device includes: an acquisition module, configured to acquire the text to be processed; and a category determination module, configured to process the text using a text classifier to obtain category information correspondingly. The text classifier is generated based on guidance information and the generative pre-trained model, and the generative pre-trained model is used to generate the target classification data and corresponding label information required to train the text classifier based on the guidance information.

The third aspect of present disclosure provides an electronic device. The electronic device includes: at least one processor; and a memory unit connected to the processor. The memory unit stores computer program instructions executable by one or more processors to implement the classification method in the present disclosure.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a flowchart of the classification method consistent with an embodiment of the present disclosure;

FIG. 2 is a flowchart of a method for determining target category information according to an embodiment of the present disclosure;

FIG. 3 is a block diagram of a classification device consistent with an embodiment of the present disclosure;

FIG. 4 is a block diagram of an electronic device consistent with an embodiment of the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

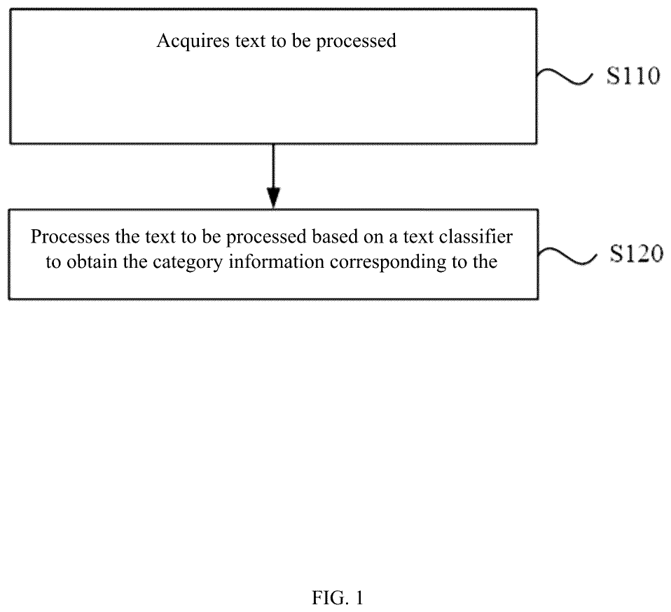

FIG. 1 is a flowchart of a classification method provided in the embodiments of the present disclosure. This method may be executed by the classification device provided in the embodiments of the present disclosure, which can be implemented in software and/or hardware. The method specifically includes the following steps.

At S110, the system acquires text to be processed. The text to be processed is text data with classification requirements.

At S120, the system processes the text to be processed based on a text classifier to obtain the category information corresponding to the text.

In one embodiment, the text classifier is generated based on classification guidance information and a generative pre-trained model, and the generative pre-trained model is used to generate the target classification data and corresponding label information needed to train the text classifier, based on the classification guidance information.

Moreover, here, the text classifier is based on a well-trained neural network models such as CNN/LSTM/Transformer, and is used to classify the input text to be processed. The classification guidance information may be any industry-related information input by the user, which can be in the form of text, voice, or image. The generative pre-trained model is a deep learning model capable of generating basic categories and data related to any industry according to user requirements, such as ChatGPT. The target classification data and its corresponding label information are the training data used to train the text classifier.

Specifically, in this embodiment, a trained text classifier can be used to classify the input text to be processed.

In the embodiment of the present disclosure, the training process of the text classifier includes using the target classification data as input, and the target category information corresponding to the target classification data as the label information, to train a neural network, thereby obtaining the text classifier. The target classification data is obtained through the following steps: obtaining the classification guidance information from input by users; processing the classification guidance information through the generative pre-trained model to obtain the target category information; and generating the target classification data corresponding to the target category information through the generative pre-trained model based on the target category information.

In one embodiment, the target category information is specific category information, and the target classification data consists of a large amount of data, which is generated for each target category information, containing the intent features corresponding to that target category information.

More specifically, in this embodiment, to accurately train a text classifier in a completely zero-resource or low-resource scenario, the primary challenge to address is the availability of training data. A generative pre-trained model is a preferable auxiliary tool. It is capable of generating the desired target category information based on the classification guidance information provided by the user. For instance, if the user's input classification guidance information is “What are the types of computer failures?”, the generative pre-trained model might output target category information such as “software failures and hardware failures”.

Note that the objective of this embodiment is to generate target classification data, therefore, the category information such as “software failure” and “hardware failure” can be used as guidance information, which can be feed into the generative pre-trained model again, to generate a large amount of data corresponding to each category. This generated data then can be used as the target classification data. For example, this embodiment may further input “provide examples of software failure” into the generative pre-trained model to obtain target classification data corresponding to “software failure.” In the end, after obtaining the target classification data, this embodiment can assign the corresponding target category information as the label information for the data, and use the target classification data as input, to train a neural network in order to obtain a well-trained text classifier.

In this embodiment, it is possible to train a text classifier for a specific vertical domain based on a generative pre-trained model, even under completely zero-resource conditions, based on the demands of any industry.

This embodiment discloses a classification method that includes: obtaining the text to be processed, and then processing the text using a text classifier to obtain corresponding category information. The text classifier is generated based on classification guidance information and a generative pre-trained model. The generative pre-trained model is used to generate the target classification data and its corresponding label information required to train the text classifier. This method effectively addresses classification tasks where there is no classification system, no data, and completely zero resources.

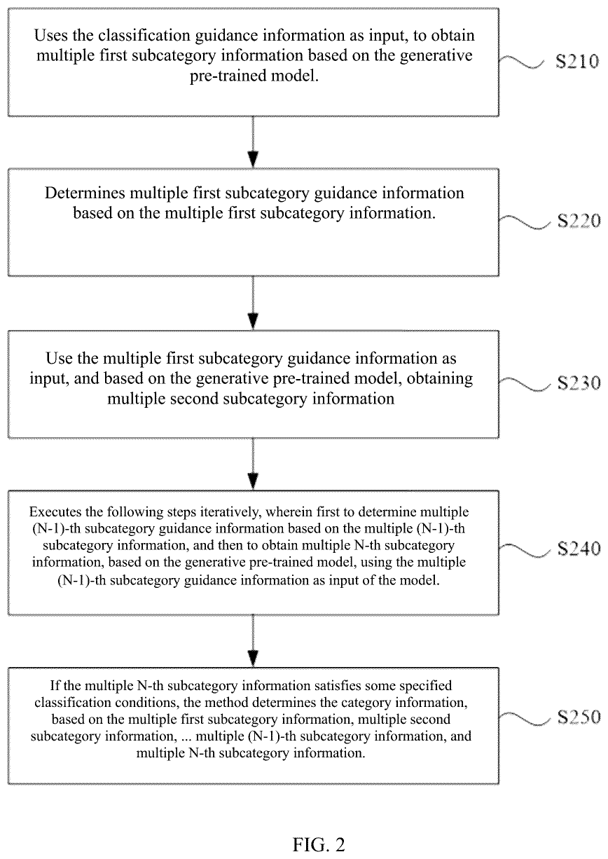

The present disclosure provides a method for determining target category information, and FIG. 2 shows a flowchart of an embodiment of the present disclosure. It includes the following steps.

At S210, the method uses the classification guidance information as input, based on the generative pre-trained model, to obtain multiple first subcategory information.

At S220, the method determines multiple first subcategory guidance information based on the multiple first subcategory information.

At S230, the method uses the multiple first subcategory guidance information as input, based on the generative pre-trained model, to obtain multiple second subcategory information.

At S240, the method iteratively executes the following steps: first to determine multiple (N−1)-th subcategory guidance information based on the multiple (N−1)-th subcategory information, and then to obtain multiple N-th subcategory information, based on the generative pre-trained model, using the multiple (N−1)-th subcategory guidance information as input of the model.

At S250, if the multiple N-th subcategory information satisfies some specified classification conditions, the method determines the category information, based on the multiple first subcategory information, multiple second subcategory information, . . . multiple (N−1)-th subcategory information, and multiple N-th subcategory information.

In this step, the classification conditions include: the number of the (N−1)-th subcategory information is equal to the number of the N-th subcategory information; or the number of the N-th subcategory information satisfies a specified quantity.

Moreover, in this step, the first subcategory information, the second subcategory information . . . the (N−1)-th subcategory information, and the N-th subcategory information are the successive layers of category information, which is obtained from using the classification guidance information as the initial input of the model. In one embodiment, N shall be a positive integer greater than two. The first subcategory guidance information is the information obtained from the generative pre-trained model, manually guided by the first subcategory information. In the same manner and running iteratively, the (N−1)-th subcategory guidance information can be derived.

More specifically, in this embodiment, the N-th subcategory information is obtained by using the (N−1)-th subcategory information as its guidance information. This results that it shall contain more specific category information, compared to the (N−1)-th subcategory information. Furthermore, if this embodiment aims to obtain even more specific and refined category information, it is necessary to continue generating the N-th subcategory information based on the (N−1)-th subcategory information. Note that because the (N−1)-th subcategory information is merely results produced by the generative pre-trained model, further human guidance is still required in the input of the generative pre-trained model. Therefore, in this embodiment, the (N−1)-th subcategory guidance information is derived from the (N−1)-th subcategory information.

For example, this embodiment illustrates the detailed process within the scenario of computer failure. First, the embodiment inputs the classification guidance information “What types of computer failures exist using a prompt? Please think step-by-step.” into the generative pre-trained model. The model's response might be “Computer failures include software failures and hardware failures” which can be used as the multiple first subcategory information. Since the scope of the first subcategory information is too broad, this embodiment requires further specific classification based on the multiple first subcategory information. Therefore, the first subcategory guidance information can be obtained based on each piece of the achieved first subcategory information, which can be input into the generative pre-trained model for further classification. For instance, based on the first subcategory information ‘software failures,’ the first subcategory guidance information can be “What types of software failures exist?”. Then by inputting “What types of software failures exist?” into the generative pre-trained model, multiple second subcategory information can be received. For example, it can be “operating system crash, application crash, computer virus infection, system freeze, system hang, and hard drive data loss”. Similarly, based on the other first subcategory information “hardware failures”, first subcategory guidance information can be formed as ‘What types of hardware failures exist?’. Then, by inputting “What types of hardware failures exist?” into the generative pre-trained model, multiple second subcategory information can be received, such as “hardware damage, power failure, hard drive failure, memory failure, CPU failure, motherboard failure, computer monitor failure, and keyboard/mouse failure”.

For better understanding, this embodiment further illustrates the process of obtaining the third subcategory information based on the second subcategory information. In this embodiment, the second subcategory guidance information can be obtained for each of the second subcategory information, and then these second subcategory guidance information can be input into the generative pre-trained model for further classification, to receive multiple third subcategory information. For example, based on the second subcategory information “hard drive failure” achieved above, the second subcategory guidance information can be “common cases of hard drive failure”. By inputting “common cases of hard drive failure” into the generative pre-trained model, multiple third subcategory information can be obtained, such as:
(1) Hard drive bad sectors: This is a common hard drive failure, indicating that a physical sector on the hard drive cannot read or write data properly.
(2) Hard drive physical damage: The hard drive may be damaged due to wear and tear, impact, or other reasons, making it unable to boot or read data.
(3) Hard drive data loss: Data on the hard drive may be lost due to hard drive failure, operating system crash, virus infection, or other issues.
(4) Hard drive read/write errors: The hard drive may fail to read or write data properly, causing the computer to malfunction.
(5) Hard drive degradation: Over time, the hard drive performance may degrade, leading to slower data read/write speeds, reduced hard drive capacity, and other related problems.

Similarly, this embodiment can continue the same process iteratively, based on the above third subcategory information. Ultimately this embodiment is about to achieve specific classification information in the scenario of computer failures.

More specifically, in this embodiment, the classification process can be stopped when the multiple N-th subcategory information satisfies some specified classification conditions. For example, the classification can be stopped, when the number of (N−1)-th subcategory information is equal to the number of N-th subcategory information. This indicates that the (N−1)-th subcategory information can no longer be further classified. Additionally, this embodiment can also define a specified number, where the classification stops when the number of N-th subcategory information reaches the defined number.

Moreover, in this embodiment, when the classification process is finished, the entire category information can be determined based on the achieved multiple first subcategory information, multiple second subcategory information . . . multiple (N−1)-th subcategory information, and multiple N-th subcategory information. This entire category information shall be utilized as the classification system for the target classification task.

In this embodiment, there is no need for any knowledge engineers to build the classification system. A complete and highly accurate classification system can be obtained based on the generative pre-trained model. Moreover, the operation is convenient and highly efficient.

In the embodiment of the present disclosure, the process of generating the target classification data corresponding to the target category information, through the generative pre-trained model, based on the target category information includes the following steps. First, determining data guidance information corresponding to each target category information based on the category information. In one embodiment, the target category information can include a single subcategory information or multiple subcategory information with some logical relations. Second, using the data guidance information as input, and based on the generative pre-trained model, determining at least one initial classification data corresponding to each target category information.

In one embodiment, the data guidance information can be the information manually guided based on the target category information, which is then input into the generative pre-trained model. The initial classification data can be any data generated according to the target category information. In one embodiment, at least one of the initial classification data includes log data which contains intent features corresponding to its target category information.

More specifically, because the training process of the text classifier in this embodiment requires a large amount of target classification data, after obtaining the overall category information, this embodiment can select the most specific N-th subcategory information as the target category information. Additionally, it also can use the first subcategory information, multiple second subcategory information . . . multiple (N−1)-th subcategory information, and multiple N-th subcategory information, as the target category information. Then, the embodiment uses the generative pre-trained model to obtain the target classification data, based on the above target category information.

Moreover, the target classification data can be any descriptive text information related to the data guidance information. For example, this embodiment is still in the computer failure scenario. Based on the above third subcategory information “Hard drive physical damage: The hard drive may be damaged due to wear and tear, impact, or other reasons, making it unable to boot or read data”, the data guidance information can be guided manually as “Provide examples of hard drive failure”. Then the content can be used as input to the generative pre-trained model, to achieve descriptive text information such as A, B . . . C, as the target classification data.

As another example, this embodiment can be further illustrated using target classification data as log data. In one embodiment, using the third subcategory information, the data guidance information can be configured manually as “Assume you are now a maintenance engineer, please write a fault log for a hard drive failure, detailing the time of the failure, symptoms, causes, and solutions”. This information is then input into the generative pre-trained model, and then it may obtain the following target classification data as an example:
“Failure Log 1: Hard Drive Failure;
Date: Feb. 9, 2023.
Reported by: OpenAI Maintenance Engineer.
Symptoms: The customer reported an error message related to the hard drive when starting the computer, indicating that data on the hard drive could not be read.
Analysis: Through further diagnosis, we found that the hard drive was faulty. Upon inspection, we discovered that the mechanical components of the hard drive were worn out, resulting in the inability to read or write data properly.
Solution: We replaced the faulty hard drive with a new one and performed data recovery to ensure the customer could retrieve their important data.
Conclusion: The issue has been resolved, and the computer is now starting up normally and can read data from the hard drive;
Notes: For detailed information regarding the fault, please refer to the technical report attached.
Failure Log 2: Hard Drive Failure;
Date: Feb. 9, 2023;
Symptoms: The customer reported a computer startup issue where the system could not load the operating system;
Investigation: Using computer diagnostic tools, we discovered multiple bad sectors on the hard drive;
Cause: Further investigation revealed that the hard drive had experienced several operating system crashes and power failures, leading to the development of multiple bad sectors;
Solution: We replaced the faulty hard drive with a new one and installed the operating system. The computer is now booting and running normally;
Notes: We recommend that the customer regularly back up their data to prevent data loss.”

In this embodiment, a large amount of data related to each target category information can be generated from the generative pre-trained model, by determining the data guidance information for each target category information and using the data guidance information. This approach helps in accumulating training data for training the text classifier. Additionally, this embodiment allows the direct use of the target category information as the label information for the target classification data. There is no need of using any annotators to label the training data, thus saving human labor and time costs.

In some embodiments of the present disclosure, the process of generating the target classification data corresponding to the target category information through the generative pre-trained model, based on the target category information, further includes: applying quality screening based on multiple initial classification data to obtain the target classification data corresponding to each target category information.

More specifically, since the initial classification data generated based on the generative pre-trained model corresponding to the target category information may contain some problems, such as grammatical errors, common sense errors, or may be irrelevant to the target category information. Therefore, this embodiment can apply quality screening to the multiple initial classification data to obtain multiple target classification data.

In this embodiment, the process of applying quality screening based on multiple initial classification data, includes at least one of the following operations: applying quality screening on the grammar of each initial classification data through a grammar checking tool; determining the relation features between the subjects of each initial classification data, through the grammar checking tool, and applying quality screening on the relation features between the subjects of each initial classification data based on a common knowledge database; extracting the keywords of the initial classification data, and applying quality screening by determining the correlation between the keywords and the target category information corresponding to each initial classification data; applying quality screening based on a semantic evaluation tool, by determining the correlation between each initial classification data and its corresponding target category information.

In one embodiment, the grammar checking tool can be any tool capable of determining syntax, grammar, and extracting the connections between entities within a sentence. Moreover, the common knowledge database can be a repository of human common knowledge.

More specifically, in this embodiment, the grammar checking tool is used to determine whether the generated sentences comply with syntax and grammar rules. In one embodiment, initial classification data that does not conform to human syntax and grammar shall be filtered out, in order to remove ill-formed data. For example, if a sentence in the initial classification data reads ‘the keyboard hits me,’ the grammar checking tool can identify this error and delete the sentence or the corresponding initial classification data.

More specifically, in this embodiment, the grammar checking tool can also utilize its entity recognition and relation extraction functionalities to extract the relation features between subjects within each sentence of the initial classification data. This allows for determining whether the generated data aligns with common sense and ethics. For example, if a sentence in the initial classification data reads “I eat the keyboard”, then the grammar checking tool would identify the relation feature between the subject “I” and “keyboard” as “eat”. However, according to the common knowledge database, the relationship feature “eat” between “I” and “keyboard” does not conform to common sense. As a result, this sentence or the corresponding initial classification data shall be deleted.

More specifically, in this embodiment, keywords from each initial classification data can also be extracted. For example, if the initial classification data obtained through the target category information “hardware damage” is “I type on the keyboard to input information”, then the extracted keywords would be “keyboard, typing, input information”. Since the correlation of these keywords to the target category information “hardware damage” is very low, this initial classification data can be deleted.

More specifically, in this embodiment, quality screening can also be performed using a semantic judgment tool. For example, if the initial classification data obtained from the target category information “hardware damage” is “a key on my keyboard does not response”, then the semantic judgment tool would assess the correlation between the initial classification data “a key on my keyboard does not response”, and the target category information “hardware damage”. Since the correlation is high, this initial classification data can pass the quality filter and be further used as the target classification data.

In this embodiment, by applying various quality screening methods, it is able to effectively filter out the data within the initial classification data which does not satisfy the requirements, and then use the remaining correct data as the target classification data. This ensures the quality of the target classification data, thereby improving accuracy of the text classifier.

In the embodiments of the present disclosure, the process of using the data guidance information as input, and based on the generative pre-trained model, determining at least one initial classification data corresponding to each target category information, includes: determining temperature-based sampling parameter of the generative pre-trained model; and using the data guidance information as input, and based on the generative pre-trained model, determining diversified initial classification data corresponding to each target category information; while modifying the temperature-based sampling parameter.

In one embodiment, temperature-based sampling parameter is a parameter of the generative pre-trained model. If modifying these parameters, the formulation of generating the initial classification data shall be also changed. Therefore, diversified data can be generated from the generative pre-trained model.

Note that when generating each word in the initial classification data, because the generative pre-trained model, selects the word with the maximum probability by default, and because the initial classification data obtained in this embodiment is intended to be used as training data for the text classifier later, the more data, the more accurate the text classifier will be. Therefore, to obtain more diversified initial classification data from the generative pre-trained model, this embodiment shall vary the temperature-based sampling parameter. By setting different temperature-based sampling parameters, it is possible to collect not only the words with the maximum probability, but also the ones with other probabilities, thereby generating diversified initial classification data.

For example, if the target category information is “hard drive failure”, and the prompt inputs the data guidance information as “Please write an example of a hard drive failure” into the model, then various responses can be achieved form setting different temperature-based sampling parameters. For instance, the initial classification data can be “The engineer discovered a faulty read/write head inside the hard drive, which caused the data to be unreadable.”

This embodiment provides a method, that by setting the temperature sampling parameters, the embodiment can obtain diversified initial classification data. This method contributes to improving accuracy of the later text classifier.

This embodiment primarily includes four key steps: classification system generation, training data generation, quality assessment, and classifier training. First, a classification system is progressively generated using a generative pre-trained model. Next, a large amount of initial classification data is generated for each subcategory information from the classification system. Then, the generated data is filtered, based on quality evaluation strategies to obtain the target classification data. Finally, a supervised classification model for the specific domain is trained, using achieved the target classification data and the corresponding target category information. In one embodiment, this embodiment does not require any knowledge engineers to build the classification system, nor does it need any annotators to label any training data upon completely zero-resource basis. Moreover, during the cold start period, it can save a significant amount of human labor and material resources. Additionally, for certain specialized fields, it can meet the requirements of protecting data confidentiality. Moreover, the entire process flow is integrated, highly operable. The generated text classifier is highly accurate and practical.

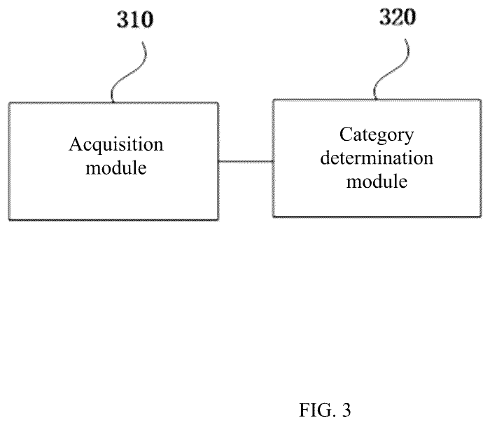

The present disclosure provides a classification device. FIG. 3 shows a schematic structural diagram of an embodiment of the classification device, which includes:

An acquisition module 310, which is configured to acquire the text to be processed;

A category determination module 320, which is configured to process the text, using a text classifier to obtain corresponding category information. The text classifier is generated based on guidance information and a generative pre-trained model. The generative pre-trained model is used to generate target classification data and corresponding label information required to train the text classifier based on the guidance information.

Another embodiment of the present disclosure, further includes:
A training module, which is configured to train a neural network using the target classification data as input and the target category information corresponding to the target classification data as label information, thereby obtaining the text classifier;
A target classification data acquisition module, which is configured to obtain the classification guidance information input by users; process the classification guidance information through the generative pre-trained model to obtain target category information; and then generate target classification data corresponding to the target category information based on the target category information through the generative pre-trained model.

In some embodiments of the present disclosure, the target classification data acquisition module is specifically configured to: use the classification guidance information as input, and based on the generative pre-trained model, obtain multiple first subcategory information; determine multiple first subcategory guidance information based on the multiple first subcategory information; use the multiple first subcategory guidance information as input, and based on the generative pre-trained model, obtain multiple second subcategory information; iteratively execute the following steps: determine multiple (N−1)-th subcategory guidance information based on the multiple (N−1)-th subcategory information, and use the multiple (N−1)-th subcategory guidance information as input, to obtain multiple N-th subcategory information based on the generative pre-trained model. When the multiple N-th subcategory information satisfies the specified classification conditions, the target classification data acquisition module is configured to determine the category information based on the multiple first subcategory information, multiple second subcategory information, . . . multiple (N−1)-th subcategory information, and multiple N-th subcategory information. The specified classification conditions include the number of the (N−1)-th subcategory information is equal to the number of the N-th subcategory information; or the number of the N-th subcategory information satisfies a specified quantity.

In some embodiments of the present disclosure, the target classification data acquisition module is further configured to: determining the data guidance information corresponding to each target category information based on the category information. The target category information includes a single subcategory information or multiple subcategory information with logical relations; and using the data guidance information as input, and based on the generative pre-trained model, determine at least one initial classification data corresponding to each target category information.

In some embodiments of the present disclosure, at least one of the initial classification data includes log data with intent features corresponding to its target category information.

In some embodiments of the present disclosure, the target classification data acquisition module is further configured to: apply quality screening based on multiple initial classification data to obtain the target classification data.

In some embodiments of the present disclosure, the process of quality screening within the target classification data acquisition module, based on multiple initial classification data, includes at least one of the following operations: applying quality screening on the grammar of each initial classification data through a grammar checking tool; determining the relation features between the subjects of each initial classification data through the grammar checking tool, and applying quality screening on the relation features between the subjects of each initial classification data based on a common knowledge database; extracting the keywords of each initial classification data, and applying quality screening by determining the correlation between the keywords and the target category information corresponding to each initial classification data; and applying quality screening based on a semantic judgment tool by determining the correlation between each initial classification data and its corresponding target category information.

In some embodiments of the present disclosure, the target classification data acquisition module is further configured to: determine the temperature sampling parameter of the generative pre-trained model; and by modifying the temperature-based sampling parameter, use the data guidance information as input to the generative pre-trained model, to generate diversified initial classification data corresponding to each target category information.

The present disclosure further provides an electronic device, and a readable storage medium.

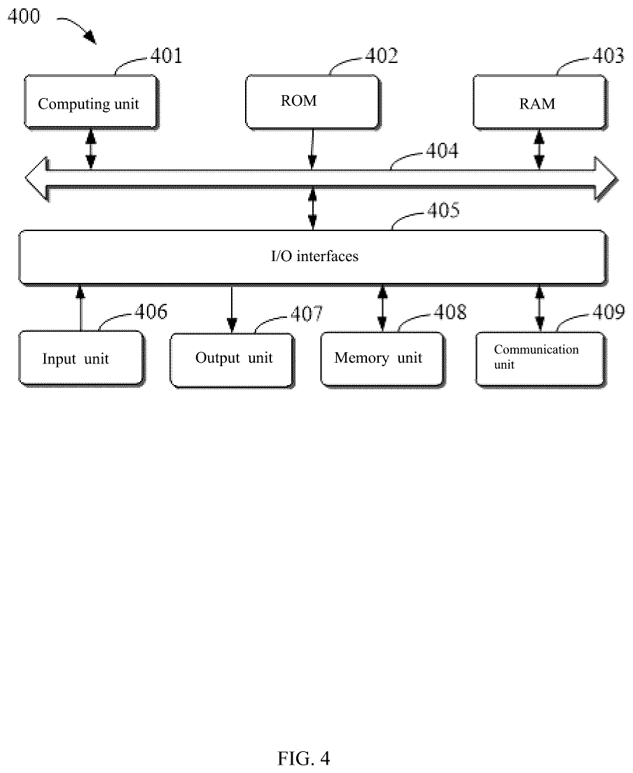

FIG. 4 is a block diagram of an electronic device 400, as the embodiments of the present disclosure. The electronic device can be various forms of digital computers, such as a laptop, desktop, workstation, personal digital assistant (PDA), server, blade server, mainframe, and other suitable computing devices. The electronic device can also be various forms of mobile devices, such as a personal digital assistant (PDA), cellular phones, smartphones, wearable device, and other similar computing devices. The components, connections and relations, and their functions shown herein are merely examples and shall not be limited to the implementations of the present disclosure described in the embodiment.

As shown in FIG. 4, the device 400 includes a computing unit 401, which can execute various appropriate operations and processes, based on a computer program stored in the Read-a Memory (ROM) 402, or a computer program loaded into the Random Access Memory (RAM) 403 from the storage unit 408. The RAM 403 can also store various programs and data necessary for the operation of the device 400. The computing unit 401, ROM 402, and RAM 403 are connected to each other via a bus 404. An input/output (I/O) interface 405 is also connected to the bus 404.

Multiple components within the device 400 are connected to the I/O interface 405, including: an input unit 406, such as a keyboard, mouse, etc.; an output unit 407, such as various types of displays, speakers, etc.; a storage unit 408, such as a disk, optical disc, etc.; and a communication unit 409, such as a network card, modem, wireless communication transceiver, etc. The communication unit 409 allows the device 400 to exchange information/data with other devices through a computer network such as the Internet and/or various telecommunication networks.

The computing unit 401 can be a general-purpose and/or specialized processing component with processing and computing capabilities. Examples of the computing unit 401 include, but are not limited to, a central processing unit (CPU), a graphics processing unit (GPU), various specialized artificial intelligence (AI) computing chips, various computing units running machine learning model algorithms, digital signal processors (DSP), and any suitable processor, controller, microcontroller, etc. The computing unit 401 executes the various methods and processes described above, such as the classification method. For example, in some embodiments, the classification method can be implemented as a computer software program that is tangibly stored in a machine-readable medium, such as the storage unit 408. In some embodiments, parts or all of the computer programs can be loaded and/or installed on the device 400 via the ROM 402 and/or the communication unit 409. When the computer program is loaded into the RAM 403 and executed by the computing unit 401, one or more steps of the classification method described above can be performed. Alternatively, in other embodiments, the computing unit 401 can be configured to execute the classification method through any other suitable means (e.g., by means of firmware).

In some embodiments of the systems and techniques described above can be implemented in digital electronic circuitry, integrated circuits, field-programmable gate arrays (FPGA), application-specific integrated circuits (ASIC), application-specific standard products (ASSP), system-on-chip (SOC), complex programmable logic devices (CPLD), computer hardware, firmware, software, and/or combinations thereof. These embodiments can be implemented in different ways as follows. The embodiment can be implemented in one or more computer programs, which can be executed and/or interpreted on a programmable system that includes at least one programmable processor. This programmable processor can be a special-purpose or general-purpose programmable processor. It receives data and instructions from a storage system, at least one input device, and at least one output device, and also transmits data and instructions towards the storage system, the at least one input device, and the at least one output device.

In the present disclosure, the program code can be written in any combination of one or more programming languages. This program code can be used on a processor or controller of a general-purpose computer, a special-purpose computer, or other programmable data processing apparatus, such that when the program code is executed, the functions/operations specified in the flowcharts and/or block diagrams are performed. The program code can be executed entirely on the machine as an integrity, or partially on the machine. It can also be as a standalone software package running partially on a local machine, and partially on a remote machine. It can also run entirely on a remote machine or server.

In the context of the present disclosure, a machine-readable medium may be a tangible medium that is able to store or contain a program for use by or in connection with an instruction execution system, apparatus, or device. The so-called machine-readable medium can be a machine-readable signal medium or a machine-readable storage medium. Moreover, the machine-readable medium may include, but shall not be limited to, electronic, magnetic, optical, electromagnetic, infrared, or semiconductor systems, apparatuses, or devices, or any suitable combination of the above. More specific examples of machine-readable storage media may include, but shall not be not limited to, electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the above.

In the present disclosure, in order to provide interactions with the user, the systems and functions can be implemented on a computer. The computer includes: a display device (such as a CRT (cathode ray tube) or LCD (liquid crystal display) monitor) for displaying information to the user; and a keyboard and a pointing device (such as a mouse or a trackball), through which the user can provide input to the computer. Moreover, other types of devices can also be used to provide interaction with the user; for example, feedback provided to the user can be in any form of sensory feedback (such as visual feedback, auditory feedback, or haptic feedback); and input from the user can be received in any form (including acoustic input, speech input, or haptic input).

In the present disclosure, the systems and techniques described in some embodiments can be implemented in a computing system that includes backend components (e.g., a data server), or a computing system that includes middleware components (e.g., an application server), or a computing system that includes frontend components (e.g., a user computer with a graphical user interface or web browser through which the user can interact with the implementations of the systems and techniques described herein), or a computing system that includes any combination of the above backend, middleware, and frontend components. The components of the system can be interconnected by any form or medium with digital data communication (e.g., a communication network). Typical examples of communication networks include: a Local Area Network (LAN), a Wide Area Network (WAN), and the Internet.

In the present disclosure, a computer system can include clients and servers. The client and server are generally remote from each other and typically interact through a communication network. The relationship between the client and server is established by computer programs that run on the respective computers and have a client-server relationship with each other. The server can be a cloud server, a server in a distributed system, or a server integrated with block-chain technology.

It should be noted that each embodiment in the specification is described in a progressive manner, and each embodiment focuses on the differences from other embodiments, and the same and similar parts between the embodiments can refer to each other.

Moreover, it should be noted that in the specification, relational terms such as first, second, third and fourth are only used to distinguish one entity or operation from another entity or operation, and do not necessarily require or imply any such actual relationship or order between these entities or operations. Moreover, the terms “include”, “comprise” or any other variant thereof are intended to cover non-exclusive inclusion, so that a process, method, article or device including a series of elements includes not only those elements, but also other elements not explicitly listed, or also includes elements inherent to such a process, method, article or device. Without further limitation, the elements defined by the sentence “including one . . . ” do not exclude the existence of other identical elements in the process, method, article or device including the elements.

The above description is merely some embodiments of the present disclosure. It should be pointed out that for ordinary technicians in this technical field, various improvements and modifications can be made without departing from the principles of the present disclosure. These improvements and modifications should also be regarded as the scope of protection of the present disclosure.

What is claimed is:

1. A classification method, which comprising:
obtaining text to be processed; and
processing the text based on a text classifier to obtain category information corresponding to the text, wherein the text classifier is generated based on classification guidance information and a generative pre-trained model, and the generative pre-trained model is used to generate target classification data and its corresponding label information needed to train the text classifier based on the classification guidance information.

2. The method according to claim 1, wherein training process of the classifier includes:
obtaining the text classifier using the target classification data as input and using target category information corresponding to the target classification data as the label information, wherein the target classification data is obtained by:
obtaining the classification guidance information from input by users;
processing the classification guidance information through the generative pre-trained model to obtain target category information; and
generating the target classification data corresponding to the target category information through the generative pre-trained model based on the target category information.

3. The method according to claim 2, wherein the process of obtaining the target category information through the generative pre-trained model includes:
using the classification guidance information as input, and based on the generative pre-trained model, obtaining multiple first subcategory information;
determining multiple first subcategory guidance information based on the multiple first subcategory information;
using the multiple first subcategory guidance information as input, and based on the generative pre-trained model, obtaining multiple second subcategory information; and
iteratively executing the following steps:
determining multiple (N−1)-th subcategory guidance information based on the multiple (N−1)-th subcategory information, and using the multiple (N−1)-th subcategory guidance information as input, obtaining multiple N-th subcategory information through the generative pre-trained model;
if the multiple N-th subcategory information satisfies classification conditions, determining the category information based on the multiple first subcategory information, the multiple second subcategory information, . . . multiple (N−1)-th subcategory information, and multiple N-th subcategory information, wherein the specified classification conditions include: a number of the (N−1)-th subcategory information equals to a number of the N-th subcategory information, or a number of the N-th subcategory information satisfies a specified quantity.

4. The method according to claim 3, wherein the process of generating the target classification data corresponding to the target category information through the generative pre-trained model, based on the target category information, includes:
determining data guidance information corresponding to each target category information based on the category information, wherein the target category information includes a single subcategory information or multiple subcategory information with logical relations; and
using the data guidance information as input, and based on the generative pre-trained model, determining at least one initial classification data corresponding to each target category information.

5. The method according to claim 4, wherein at least one of the initial classification data includes log data which contains intent features corresponding to its target category information.

6. The method according to claim 4, wherein the process of generating the target classification data corresponding to the target category information through the generative pre-trained model, based on the target category information, further includes:
applying quality screening based on multiple initial classification data to obtain the target classification data corresponding to each target category information.

7. The method according to claim 6, wherein the process of applying quality screening based on the multiple initial classification data includes at least one of the following operations:
applying quality screening on grammar of each initial classification data through a grammar checking tool;
determining the relation features between subjects of each initial classification data, through the grammar checking tool, and applying quality screening on the relation features between the subjects of each initial classification data based on a common knowledge database;
extracting keywords of the initial classification data, and applying quality screening by determining correlation between the keywords and the target category information corresponding to each initial classification data;
applying quality screening based on a semantic evaluation tool, by determining the correlation between each initial classification data and its corresponding target category information.

8. The method according to claim 4, wherein the process of using the data guidance information as input, and based on the generative pre-trained model, determining at least one initial classification data corresponding to each target category information, includes:
determining temperature-based sampling parameter of the generative pre-trained model; and
using the data guidance information as input, and based on the generative pre-trained model, determining diversified initial classification data corresponding to each target category information, while modifying the temperature-based sampling parameter.

9. A classification device, comprising:
an acquisition module, which is configured to acquire text to be processed; and
a category determination module configured to process the text, using a text classifier to obtain corresponding category information, wherein the text classifier is generated based on guidance information and a generative pre-trained model, wherein the generative pre-trained model is used to generate target classification data and corresponding label information required to train the text classifier based on the guidance information.

10. An electronic device comprising:
at least one processor; and
a memory unit connected to the processor; wherein
the memory unit stores instructions executable by one or more processors to implement a classification method, the classification method comprising:
obtaining text to be processed; and
processing the text to be processed based on a text classifier to obtain category information corresponding to the text, wherein the text classifier is generated based on classification guidance information and a generative pre-trained model, and the generative pre-trained model generates target classification data and its corresponding label information needed to train the text classifier, based on the classification guidance information.

11. The electronic device according to claim 10, wherein the training process of the classifier includes:
obtaining the text classifier based on the target category information corresponding to the target classification data as the label information and using the target classification data as input, wherein the target classification data is obtained by:
obtaining the classification guidance information from input by users;
processing the classification guidance information through the generative pre-trained model to obtain target category information; and
generating the target classification data corresponding to the target category information through the generative pre-trained model based on the target category information.

12. The electronic device according to claim 11, wherein the process of obtaining the target category information through the generative pre-trained model includes:
using the classification guidance information as input, and based on the generative pre-trained model, obtaining multiple first subcategory information;
determining multiple first subcategory guidance information based on the multiple first subcategory information;
using the multiple first subcategory guidance information as input, and based on the generative pre-trained model, obtaining multiple second subcategory information; and
iteratively executing the following steps:
determining multiple (N−1)-th subcategory guidance information based on the multiple (N−1)-th subcategory information, and using the multiple (N−1)-th subcategory guidance information as input, obtaining multiple N-th subcategory information through the generative pre-trained model;
if the multiple N-th subcategory information satisfies the specified classification conditions, determining the category information based on the multiple first subcategory information, the multiple second subcategory information, . . . multiple (N−1)-th subcategory information, and multiple N-th subcategory information; wherein, the specified classification conditions include: the number of the (N−1)-th subcategory information is equal to the number of the N-th subcategory information, or the number of the N-th subcategory information satisfies a specified quantity.

13. The electronic device according to claim 12, wherein the process of generating the target classification data corresponding to the target category information through the generative pre-trained model, based on the target category information, includes:
determining data guidance information corresponding to each target category information based on the category information, wherein the target category information includes a single subcategory information or multiple subcategory information with logical relations; and
using the data guidance information as input, and based on the generative pre-trained model, determining at least one initial classification data corresponding to each target category information.

14. The electronic device according to claim 13, wherein at least one of the initial classification data includes log data which contains intent features corresponding to its target category information.

15. The electronic device according to claim 13, wherein the process of generating the target classification data corresponding to the target category information through the generative pre-trained model, based on the target category information, further includes:
applying quality screening based on multiple initial classification data to obtain the target classification data corresponding to each target category information.

16. The electronic device according to claim 15, wherein the process of applying quality screening based on the multiple initial classification data includes at least one of the following operations:
applying quality screening on the grammar of each initial classification data through a grammar checking tool;
determining the relation features between the subjects of each initial classification data, through the grammar checking tool, and applying quality screening on the relation features between the subjects of each initial classification data based on a common knowledge database;
extracting the keywords of the initial classification data, and applying quality screening by determining the correlation between the keywords and the target category information corresponding to each initial classification data;
applying quality screening based on a semantic evaluation tool, by determining the correlation between each initial classification data and its corresponding target category information.

17. The electronic device according to claim 13, wherein the process of using the data guidance information as input, and based on the generative pre-trained model, determining at least one initial classification data corresponding to each target category information includes:
determining temperature-based sampling parameters of the generative pre-trained model; and
using the data guidance information as input, and based on the generative pre-trained model, determining diversified initial classification data corresponding to each target category information, while modifying the temperature-based sampling parameter.
